(19) United States
(12) Patent Application Publication
(10) Pub. No.: US 2008/0114819 A1
(43) Pub. Date: May 15, 2008

(54) Method and Apparatus for Storage, Retrieval, and Synchronization of Multimedia Data

(75) Inventors: Peter T. vom Scheidt, Elma, NY (US); Lin Shih Chieh, Hsinchu City (TW); Wu Heng-Chang, Linnei Township (TW); Liou Yi-Jr, Hsinchu City (TW)

Correspondence Address: EDELL, SHAPIRO & FINNAN, LLC, 1901 RESEARCH BOULEVARD, SUITE 400, ROCKVILLE, MD, 20850, US

(73) Assignee: MATTEL, INC., El Segundo, CA (US)

(21) Appl. No.: 11/746,283

(22) Filed: May 9, 2007

Related U.S. Application Data
(60) Provisional application No. 60/800,398, filed on May 16, 2006.

(51) Int. Cl. G06F 17/30

(52) U.S. Cl. 707/204

(57) ABSTRACT

An embodiment of the present invention embeds image data within a multimedia file including audio information in a manner providing storage capacity tailored to the size of the image. Thus, the resulting file structure for audio content is tailored to incorporate image data, where the image data is an integral part of the file structure. In addition, embedded image data is synchronized with audio information to enable display of the images at specific instances of an audio presentation. Synchronization data is further integrated in the multimedia file, where audio, image and synchronization data are bound together in the same file and format. This allows the file to have any sufficient size and to display and synchronize all desired images with an audio presentation.

### CROSS-REFERENCE TO RELATED APPLICATIONS

This application claims priority from U.S. Provisional Patent Application Ser. No. 60/800,398, entitled “Method and Apparatus for Storage, Retrieval, and Synchronization of Multimedia Data” and filed May 16, 2006, the disclosure of which is incorporated herein by reference in its entirety.

### BACKGROUND OF THE INVENTION

1. Technical Field

The present invention embodiments pertain to storage, retrieval, and synchronization of multimedia data. In particular, the present invention embodiments pertain to embedding image data within audio information in a manner accommodating various sized images and enabling synchronization of the embedded image data with specific instances of an audio presentation.

2. Discussion of Related Art

Digital audio information is typically stored in a file for use by a processing system to provide audio presentations to a user. For example, MP3 type files typically include audio information to play music. These types of file formats may further include a tag disposed prior to and/or subsequent the audio content and containing text describing the music and associated image data. However, the tag includes a specific total size limitation. This may limit the amount of image information stored in the file, thereby restricting the image resolution and types of stored images. Further, since the tag is a separate item added to the MP3 file, additional specific processing is needed to process the tag.

### SUMMARY OF THE INVENTION

Accordingly, the present invention embodiments embed image data within a multimedia file including audio information in a manner providing storage capacity tailored to the size of the image. Thus, the resulting file structure of the present invention embodiments for audio content is tailored to incorporate image data, where the image data is an integral part of the file structure. In addition, the present invention embodiments synchronize the embedded image data with audio information to enable display of the images at specific instances of an audio presentation. Synchronization data is further integrated in the multimedia file, where audio, image and synchronization data are bound together in the same file and format. This allows the file to have any sufficient size and to display and synchronize all desired images with an audio presentation.

The above and still further features and advantages of the present invention will become apparent upon consideration of the following detailed description of specific embodiments thereof, particularly when taken in conjunction with the accompanying drawings wherein like reference numerals in the various figures are utilized to designate like components.

### BRIEF DESCRIPTION OF THE DRAWINGS

FIG. 1 is a diagrammatic illustration of a network topology employed by a present invention embodiment to transfer multimedia information to a user multimedia device.

FIGS. 2A-2C are illustrations of an exemplary data structure or file format for embedding and synchronizing image data with audio information according to a present invention embodiment.

FIG. 3A is an illustration of an exemplary file format indicating selected songs for playback to a user according to a present invention embodiment.

FIG. 3B is an illustration of an exemplary file format indicating selected stories for presentation to a user according to a present invention embodiment.

### DETAILED DESCRIPTION

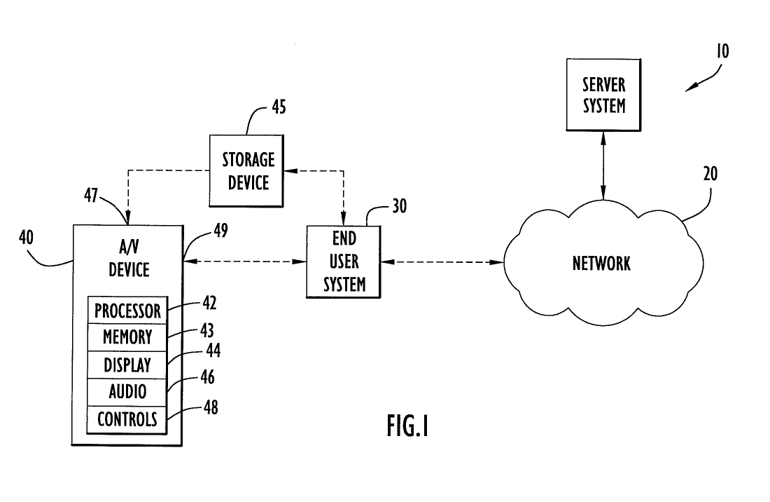

An exemplary network topology for transferring multimedia data according to a present invention embodiment is illustrated in FIG. 1. Specifically, the topology includes one or more server systems 10, a network 20 and one or more end-user systems 30. The end-user and server systems 30, 10 may be implemented by any conventional or other computer systems preferably equipped with a display or monitor, a base (e.g., including the processor, memories and/or internal or external communications devices (e.g., modem, network cards, etc.)) and optional input devices (e.g., a keyboard, mouse or other input device). End-user system 30 is coupled to server system 10 via network 20. Network 20 may be implemented by any quantity of any suitable communications media (e.g., WAN, LAN, Internet, Intranet, etc.). The end-user system 30 may be local to or remote from the server system 10.

The server system 10 stores various multimedia information for downloading to end-user system 30. The end-user system 30 may be utilized to transfer the multimedia information to a multimedia or audio/visual (A/V) device 40 for presentation to a user. Device 40 typically includes a processor 42 to process multimedia information, a memory unit 43 to store multimedia and other information, a display or monitor 44, audio components 46 (e.g., speakers, etc.) to provide audio signals to the user and input devices or controls 48 to control operation of the device 40. The components of device 40 may be implemented by any conventional or other components performing the desired functions (e.g., speaker, microprocessor, circuitry, display device, memory device, buttons, joystick, etc.). The device 40 may further include a communication port 49 (e.g., Universal Serial Bus (USB) port, etc.) to communicate with end-user system 30 and receive the multimedia information for storage in memory unit 43. Alternatively, the multimedia information may be stored on a storage device 45 that is removably coupled to or accessed by A/V device 40 via a connection port 47. The storage device 45 may be implemented by any conventional or other storage unit (e.g., card, cartridge, memory unit, memory stick, Secure Digital (SD) card, etc.) and may be pre-loaded with the multimedia information or receive that information from end-user system 30. Ports 47, 49 may be implemented by any conventional or other ports enabling access or communication with external devices (e.g., USB, wireless, SD card port, etc.).

By way of example only, A/V device 40 presents multimedia information to the user in the form of a story or song. The multimedia information includes image data embedded therein to enable the images to be displayed by device 40 during an audio presentation of the story or song. The present invention embodiments embed the image data within audio content while tailoring to the size of each image. In addition, the present invention embodiments synchronize the embedded images to the audio information to enable display of the images at specific instances of the audio presentation as described below.

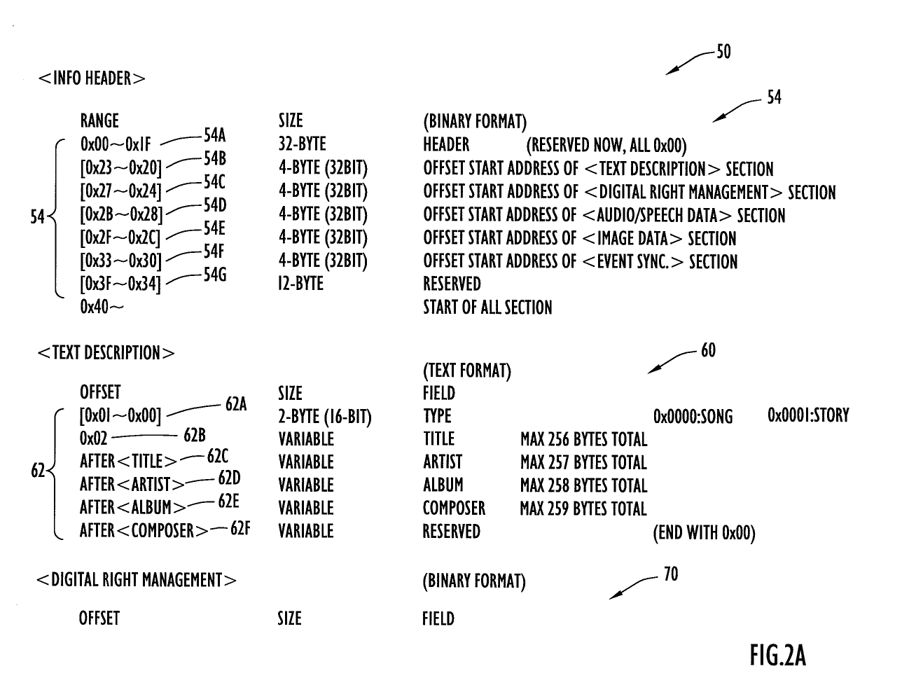

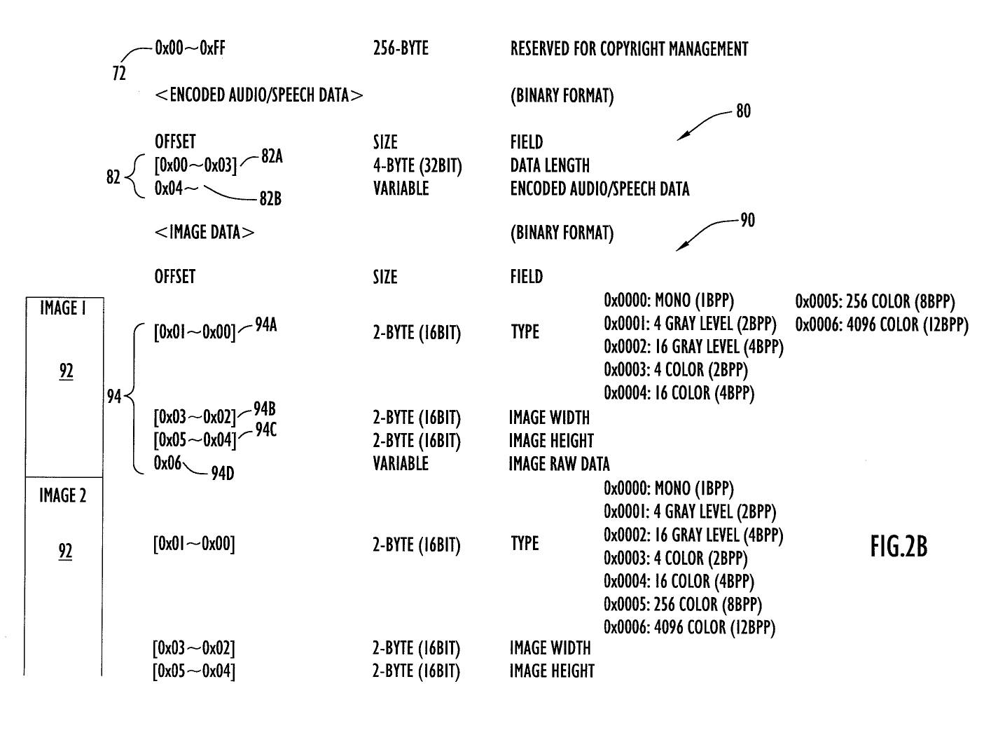

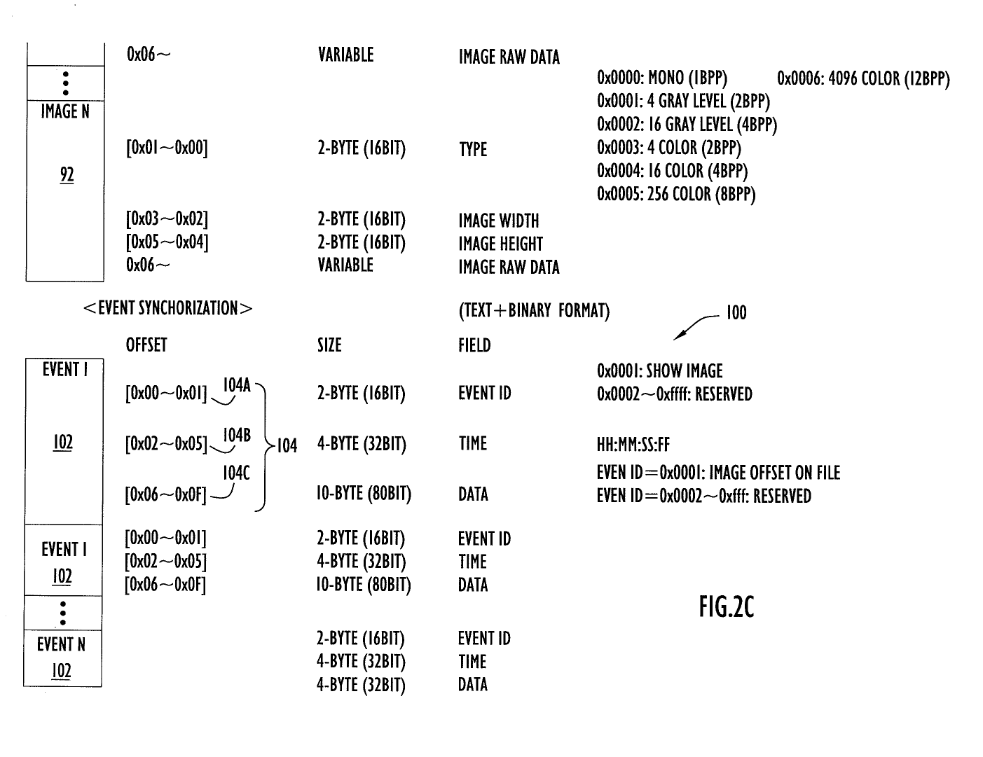

An exemplary data structure or file format to embed image data within audio content according to a present invention embodiment is illustrated in FIGS. 2A-2C. Initially, the file format and corresponding fields are preferably configured for use by a processor with a sixteen bit format; however, the file format and fields may be modified accordingly to accommodate any suitable processor configuration. In particular, a file format to store multimedia information includes an information header section 50, a text description section 60, a digital rights management section 70, an encoded audio section 80, an image data section 90 and an event synchronization section 100. Information header section 50 includes information indicating the locations of the other sections within the file (e.g., text description section 60, digital rights management section 70, encoded audio section 80, image data section 90, event synchronization section 100, etc.), while text description section 60 includes information associated with characteristics of the multimedia information (e.g., title, artist, album, author, composer, etc.) as described below.

Digital rights management section 70 includes information relating to access and use rights for the multimedia information with encoded audio section 80 including encoded audio and/or speech data (e.g., information to reproduce audio and/or speech, such as a song or story) as described below. Image data section 90 includes the embedded image data, while event synchronization section 100 includes information synchronizing the embedded image data with the encoded audio content to display the embedded images at specific instances of the audio information as described below.

Information header section 50 includes information indicating the locations of the other sections (e.g., text description section 60, digital rights management section 70, encoded audio section 80, image data section 90, event synchronization section 100, etc.) within the file. This information is in the form of an offset address or, in other words, the location or displacement of a section relative to the start of the file. Information header section 50 includes a plurality of fields 54 to contain information relating to the file format. By way of example, information section 50 includes a header field 54A, a text description field 54B, a digital rights management field 54C, an encoded audio field 54D, an image data field 54E, an event synchronization field 54F and an additional field 54G. These fields 54A-G preferably store corresponding information in the form of binary data.

Header field 54A includes header information, and occupies the initial thirty-two bytes of section 50 (e.g., hexadecimal address range of 00-1F within header information section 50). This field 54A may contain various information about the file and/or multimedia information (e.g., length, size, encoding scheme, etc.). Text description field 54B includes the offset address or location relative to the start of the file for text description section 60. The text description field 54B includes four bytes (i.e., thirty-two bits) and is sequentially disposed within section 50 (e.g., hexadecimal address range of 20-23 within header information section 50) after header field 54A.

Digital rights management field 54C includes the offset address or location relative to the start of the file for digital rights management section 70. The digital rights management field 54C includes four bytes (i.e., thirty-two bits) and is sequentially disposed within section 50 (e.g., hexadecimal address range of 24-27 within header information section 50) after text description field 54B. Encoded audio field 54D includes the offset address or location relative to the start of the file for encoded audio section 80. The encoded audio field 54D includes four bytes (i.e., thirty-two bits) and is sequentially disposed within section 50 (e.g., hexadecimal address range of 28-2B within header information section 50) after digital rights management field 54C.

Image data field 54E includes the offset address or location relative to the start of the file for image data section 90. The image data field includes four bytes (i.e., thirty-two bits) and is sequentially disposed within section 50 (e.g., hexadecimal address range of 2C-2F within header information section 50) after encoded audio field 54D. Event synchronization field 54F includes the offset address or location relative to the start of the file for event synchronization section 100. The event synchronization field 54F includes four bytes (i.e., thirty-two bits) and is sequentially disposed within section 50 (e.g., hexadecimal address range of 30-33 within header information section 50) after encoded audio field 54E. Additional field 54G includes twelve bytes and is currently reserved. This field 54G is sequentially disposed within section 50 (e.g., hexadecimal address range of 34-3F within header information section 50) after event synchronization field 54F.

Text description section 60 includes information associated with characteristics of the multimedia information (e.g., title, artist, album, author/composer, etc.) and is sequentially disposed within the file after header information section 50. Text description section 60 includes a plurality of fields 62 to contain information relating to the multimedia information. By way of example, text description section 60 includes a type field 62A, a title field 62B, an artist field 62C, an album field 62D, a composer field 62E, and an additional field 62F. These fields 62A-F preferably store corresponding information in the form of text.

Type field 62A indicates the type of multimedia content (e.g., song or story). The type field 62A occupies the initial two bytes (i.e., sixteen bits) of text description section 60 (e.g., hexadecimal address range of 00-01 within text description section 60) and preferably stores a specific value to indicate the type of multimedia content (e.g., a value of zero to indicate a song and a value of one to indicate a story). However, any desired values may be utilized to indicate any desired types of multimedia content. This field is typically utilized by device 40 to display appropriate information or menus to the user in accordance with the type of multimedia content (e.g., song, story, etc.) within the file. Title field 62B includes information indicating the title of the work (e.g., song, story, etc.) within the multimedia data. The title field 62B may include a maximum of two-hundred fifty-six bytes and is sequentially disposed within section 60 after type field 62A. Artist field 62C includes information indicating the artist of the work within the multimedia data. The artist field 62C may include a maximum of two-hundred fifty-seven bytes and is sequentially disposed within section 60 after title field 62B.

Album field 62D includes information indicating the album containing the work within the multimedia data. The album field 62D may include a maximum of two-hundred fifty-eight bytes and is sequentially disposed within section 60 after artist field 62C. Composer field 62E includes information indicating the author/composer of the work within the multimedia data. The composer field 62E may include a maximum of two-hundred fifty-nine bytes and is sequentially disposed within section 60 after album field 62D. Additional field 62F is currently reserved and generally utilized to align the ending boundary of text description section 60 (e.g., used as filler to align the end of section 60 with a particular address or boundary). This field 62F is sequentially disposed within section 60 after composer field 62E.

Digital rights management section 70 includes information relating to access and use rights (e.g., license information, etc.) for the multimedia information and is sequentially disposed within the file after text description section 60. Digital rights management section 70 includes a rights field 72 including two hundred fifty-six bytes (e.g., hexadecimal address range of 00-FF within digital rights management section 70) and containing information relating to copyright management (e.g., license information). This information is utilized to prevent unauthorized access, use and/or copying of the multimedia information and may be pre-stored in the file or, alternatively, may be provided by server system 10 (FIG. 1) during a download. The rights field 72 preferably stores the corresponding information in the form of binary data.

Encoded audio section 80 includes encoded audio and/or speech data (e.g., information to reproduce audio and/or speech, such as a song or story) and is sequentially disposed within the file after digital rights management section 70. Encoded audio section 80 includes a plurality of fields 82 to contain information relating to the actual audio content (e.g., a song or speech conveying a story). By way of example, encoded audio section 80 includes a length field 82A and an audio field 82B. These fields 82A-B preferably store corresponding information in the form of binary data.

Length field 82A indicates the length of the audio field or the amount of data for the audio content. The length field 82A occupies the initial four bytes (i.e., thirty-two bits) of encoded audio section 80 (e.g., hexadecimal address range of 00-03 within encoded audio section 80). Audio field 82B includes actual audio content (e.g., a song or speech conveying a story). The audio field 82B is of variable length and may include any desired storage capacity to accommodate the audio content. The audio field 82B is sequentially disposed within encoded audio section 80 after length field 82A.

Image data section 90 includes the embedded image data and is sequentially disposed within the file after encoded audio section 80. Image data section 90 includes one or more image sections 92 each sequentially disposed within image data section 90. Each image section 92 is associated with a particular image and a plurality of fields 94 that contain information relating to that image. By way of example, image data section 90 includes for each image section 92 an image type field 94A, an image width field 94B, an image height field 94C, and an image field 94D. These fields 94A-D preferably store corresponding information in the form of binary data.

Image type field 94A indicates the type or format of the image content (e.g., monochromatic, gray scale, color, etc.). The image type 94A field occupies the initial two bytes (i.e., sixteen bits) of an image section 92 (e.g., hexadecimal address range of 00-01 within the image section) and preferably stores a specific value to indicate the type or format of the image (e.g., a value of zero to indicate a monochromatic image, a value of one to indicate an image including four gray levels with two bits for each image pixel, a value of two to indicate an image with sixteen gray levels with four bits for each image pixel, a value of three to indicate an image including four colors with two bits for each image pixel, a value of four to indicate an image including sixteen colors with four bits for each image pixel, a value of five to indicate an image including two hundred fifty-six colors with eight bits for each image pixel and a value of six to indicate an image including 4,096 colors with twelve bits for each image pixel). However, any desired values may be utilized to indicate any desired types or formats of the image.

Image width field 94B includes information indicating the width of the associated image. The image width field 94B includes two bytes (i.e., sixteen bits) and is sequentially disposed within an image section 92 (e.g., hexadecimal address range of 02-03 within the image section) after image type field 94A. Image height field 94C includes information indicating the height of the associated image. The image height field 94C includes two bytes (i.e., sixteen bits) and is sequentially disposed within an image section 92 (e.g., hexadecimal address range of 04-05 within the image section) after image width field 94B. Image field 94D includes actual image data and is of variable length. This enables the image field 94D to include any desired storage capacity to accommodate the image data. Since the field size is not pre-defined, the present invention embodiments tailor to the sizes of each individual image, thereby accommodating any image resolutions and types of images as described above. A succeeding image section 92 starts at the end of the image field 94D of a preceding image section.

Event synchronization section 100 includes information indicating particular events and synchronizing data with those events (e.g., synchronizing the embedded images with specific instances of the audio content for display), and is sequentially disposed within the file after image data section 90. Event synchronization section 100 includes one or more event sections 102 each sequentially disposed within event synchronization section 100. Each event section 102 is associated with a particular event (e.g., displaying an image in image data section 90) and includes a plurality of fields 104 that contain information relating to that event. By way of example, event synchronization section 100 includes for each event section 102 an event identification field 104A, a time field 104B, and an image address field 104C. Event identification field 104A preferably stores corresponding information in the form of text, while time field 104B and image field 104C each preferably store corresponding information in the form of binary data.

Event identification field 104A indicates the type of a desired event (e.g., display of an associated image). The event identification field 104A occupies the initial two bytes (i.e., sixteen bits) of an event section 102 (e.g., hexadecimal address range of 00-01 within the event section) and preferably stores a specific value to indicate the type of event (e.g., a value of one indicates display of an image). However, any desired values may be utilized to indicate any types of events.

Time field 104B includes information indicating the time (e.g., hours/minutes/seconds format (HH:MM:SS)) of an event. By way of example, this field 104B may indicate the time within a multimedia presentation (e.g., time within the song or story of the encoded audio data) to display an image. The time field 104B includes four bytes (i.e., thirty-two bits) and is sequentially disposed within an event section 102 (e.g., hexadecimal address range of 02-05 within the event section) after event identification field 104A. Image address field 104C includes the offset address or location within the file of the image to be displayed (e.g., the location of an image section 92 containing the image to be displayed and the corresponding image information) when the event identification field 104A indicates the event to include display of an image (e.g., the event identification includes a value of one as described above). The image address field 104C includes ten bytes (i.e., eighty bits) and is sequentially disposed within an event section 102 (e.g., hexadecimal address range of 06-0F within the event section) after time field 104B. A succeeding event section 102 starts at the end of an image address field 104C of a preceding event section. Thus, the present invention embodiments enable images to be synchronized with specific instances of the audio content, where the images displayed for the audio content may be controlled and changed in any desired fashion.

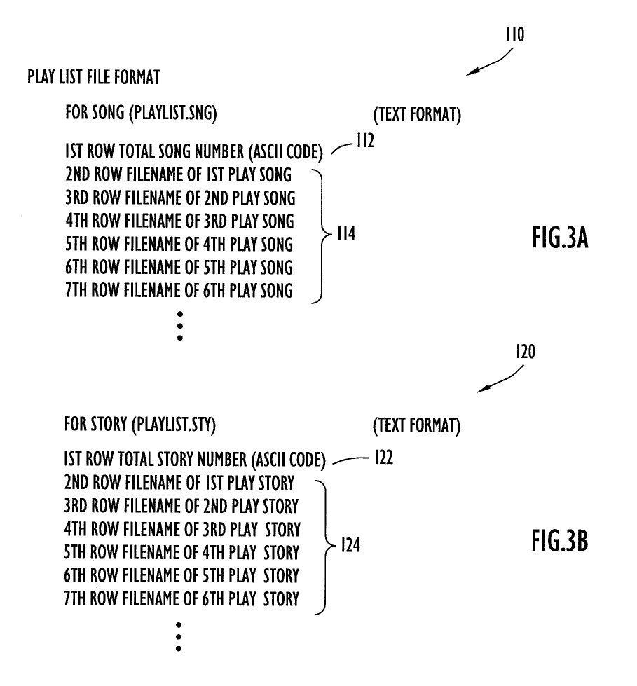

The file format described above includes information for a single multimedia presentation (e.g., one song or story). However, an additional format may be employed to enable presentation of plural sequential multimedia presentations (e.g., songs or stories). An exemplary file format for a plurality of mulitmedia presentations in the form of songs is illustrated in FIG. 3A. Specifically, the file format includes a list 110 of information pertaining to the desired songs. List 110 includes a song quantity field 112 and a plurality of filename fields 114. These fields 112, 114 preferably store corresponding information in the form of text (e.g., ASCII codes, etc.). The song quantity field 112 includes the desired quantity of songs, while the filename fields 114 each include the filename of a corresponding file arranged in the format described above (FIGS. 2A-2C) and including a desired song and corresponding images. The quantity of filename fields 114 within the file is based on the quantity of songs indicated in the song quantity field 112 (e.g., one filename for each desired song). Device 40 (see FIG. 1) retrieves the information from list 110 and accesses the indicated files to sequentially present the songs and associated images to a user. The file format with desired songs may be created by a user on end-user system 30 (see FIG. 1), where the created file format and associated multimedia files are downloaded to device 40 for storage in memory unit 43. In this case, the created file format may indicate various songs within an electronic album. Alternatively, the file format may be created by a user on device 40.

An exemplary file format for a plurality of mulitmedia presentations in the form of stories is illustrated in FIG. 3B. Specifically, the file format is similar to the format described above for FIG. 3A and includes a list 120 of information pertaining to the desired stories. List 120 includes a story quantity field 122 and a plurality of filename fields 124. These fields 122, 124 preferably store corresponding information in the form of text (e.g., ASCII codes, etc.). The story quantity field 122 includes the desired quantity of stories, while the filename fields 124 each include the filename of a corresponding file arranged in the format described above (FIGS. 2A-2C) and including a desired story and corresponding images. The quantity of filename fields 124 within the file is based on the quantity of stories indicated in the story quantity field 122 (e.g., one filename for each desired story). Device 40 (FIG. 1) retrieves the information from list 120 and accesses the indicated files to sequentially present the stories and associated images to a user. The file format with desired stories may be created by a user on end-user system 30 (FIG. 1), where the created file format and associated multimedia files are downloaded to device 40 for storage in memory unit 43. In this case, the created file format may indicate various chapters within an electronic storybook. Alternatively, the file format may be created by a user on device 40.

Operation of a present invention embodiment is described with reference to FIGS. 1, 2A-2C and 3A-3B. Initially, a user desires to initiate a multimedia presentation (e.g., song or story) on device 40. The user may convey multimedia information to device 40 in the format described above via removable storage device 45 (e.g., card, cartridge, etc.) preloaded with the desired presentation. Alternatively, the user may retrieve one or more desired presentations from server system 10 for downloading to device 40 or storage device 45 via end-user system 30 as described above. Further, the user may utilize lists 110, 120 (FIGS. 3A-3B) to indicate a plurality of desired multimedia presentations.

Once device 40 receives the multimedia information, the user may manipulate device controls 48 to select and initiate the desired presentation. Device processor 42 retrieves the file formatted as described above (FIGS. 2A-2C) and associated with the desired presentation to provide the presentation to the user. In particular, processor 42 utilizes header information section 50 within the associated file to determine the locations of the other file sections (e.g., text description section 60, digital rights management section 70, encoded audio section 80, image data section 90, event synchronization section 100, etc.) containing information for the presentation. The processor 42 initially verifies the user rights to view the presentation based on the information within digital rights management section 70. This information may be pre-stored in the file or, alternatively, may be provided by server system 10 during a download to prevent unauthorized access and copying of the multimedia information as described above. Processor 42 subsequently accesses the encoded audio information within encoded audio section 80 to start the story or song in response to proper verification.

During playback of the story or song to a user via audio devices 46, the processor 42 utilizes the information within event synchronization section 100 (e.g., time field 104B, image address field 104C, etc.) to display a corresponding image in image data section 90 on display 44 at an appropriate time within the story or song. In addition, processor 42 may display information stored in text description section 60 (e.g., title, artist, album, composer, etc.) on display 44 pertaining to the story or song. In the case of a list, the processor successively retrieves the list entries or filenames (FIGS. 3A-3B) and processes the associated files in the manner described above to provide the desired presentations. Device controls 48 may be manipulated by the user to control the presentation and/or information displayed (e.g., start, stop, replay, reverse scan, forward scan, selection, display information, create lists, etc.).

It will be appreciated that the embodiments described above and illustrated in the drawings represent only a few of the many ways of implementing a method and apparatus for storage, retrieval and synchronization of multimedia data.

The network topology employed by the present invention embodiments may include any quantity of end-user systems and server systems. The end-user and server systems employed by the present invention embodiments may be implemented by any quantity of any personal or other type of computer system (e.g., IBM-compatible, Apple, Macintosh, laptop, palm pilot, etc.), and may include any commercially available operating system (e.g., Windows, OS/2, Unix, Linux, etc.) and any commercially available or custom software (e.g., browser software, communications software, server software, etc.). These systems may include any types of monitors and input devices (e.g., keyboard, mouse, voice recognition, etc.) to enter and/or view information. The computer systems of the present invention embodiments may alternatively be implemented by any type of hardware and/or other processing circuitry.

The communication network may be implemented by any quantity of any type of communications network (e.g., LAN, WAN, Internet, Intranet, VPN, etc.). The computer systems of the present invention embodiments (e.g., end-user systems, server systems, etc.) may include any conventional or other communications devices to communicate over the network via any conventional or other protocols. The computer systems (e.g., end-user system, server system, etc.) may utilize any type of connection (e.g., wired, wireless, etc.) for access to the network.

The data structures or file formats of the present invention embodiments may be available on any suitable recordable and/or computer readable medium (e.g., magnetic or optical mediums, magneto-optic mediums, floppy diskettes, CD-ROM, DVD, memory devices, cards, sticks, cartridges, etc.) for use on stand-alone systems or devices, or systems or devices connected by a network or other communications medium, and/or may be downloaded (e.g., in the form of carrier waves, packets, etc.) to systems or devices via a network or other communications medium. The removable storage device may be implemented by any conventional or other memory or other device with a computer readable medium (e.g., card, memory stick, cartridge, etc.) to store information. The removable storage device may include any suitable storage capacity (e.g., kilobytes, megabytes, gigabytes, etc.). The removable storage device may alternatively be integral with or permanently attached to the A/V device.

The A/V device 40 may be implemented by any suitable processing device to provide a multimedia presentation. The device processor 42 may be implemented by any conventional or other processing device or circuitry, while the memory unit may be implemented by any quantity of any conventional or other type of memory device (e.g., RAM, etc.) with any suitable storage capacity (e.g., kilobytes, megabytes, gigabytes, etc.). The device 40 may include any quantity of any conventional or other types of audio components 46 to convey audio signals to a user (e.g., speakers, headphone or other jacks or ports, etc.). The device 40 may include any type of conventional or other display 44 of any shape or size (e.g., LCD, LED, etc.) and any quantity of any types of ports 47, 49 (e.g., USB, card ports, cartridge ports, network ports, etc.) to communicate with any external devices. The device 40 may include any quantity of any types of input devices (e.g., buttons, slides, switches, joystick, dials, keys, etc.) to enter any information and/or control any desired device functions (e.g., volume, brightness, selection, reverse scan, forward scan, etc.). The device components 42, 43, 44, 46, 47, 48, and 49 may be arranged in any desired fashion and disposed at any suitable device locations.

The data structure or file format of the present invention embodiments may include any quantity of sections, each including any quantity of fields to store any desired information (e.g., actual data, attributes, etc.). The sections and/or fields may be arranged in any desired fashion or order. The sections and/or fields may include any desired information to delineate boundaries for the audio, images or other information (e.g., start and ending addresses for content, special symbols or delimiters for the content, a length field indicating the length of the content, etc.). The reserved fields may be utilized to store any desired information for any suitable purpose. The data structure may be formatted for compatibility with any suitable processor configuration (e.g., sixteen bit, thirty-two bit, etc.). The fields may be of any quantity, may include any desired storage capacity or length, and may store any desired information, where the data may be of any type or form (e.g., numeric, text or string, integer, real, binary, hexadecimal, octal, etc.). The header information section 50 may include any quantity of fields to store any suitable pointers or addresses (e.g., direct addresses, offsets or indirect addresses relative to any suitable starting address, etc.) to indicate the locations of other sections. The header field may include any desired information.

The text description section 60 may include any quantity of fields to store any desired attributes (e.g., title, composer, album, artist, year, etc.) of the multimedia information. The multimedia type may be indicated by any desired alphanumeric or other values to indicate any types of multimedia content (e.g., story, song, etc.). The digital rights management section 70 may include any quantity of fields to store any desired information pertaining to access or other rights (e.g., copy, play, display, etc.) for the multimedia content. The encoded audio section 80 may include any quantity of fields to store the audio content and/or any desired attributes (e.g., length, etc.) of that content. The audio content may include a plurality of selections, where each selection may be stored in one or more fields. The audio content may be encoded in any desired fashion (e.g., compressed, encrypted, formatted, raw, etc.).

The image data section 90 may include any quantity of images 92. The images 92 may be of any type or resolution (e.g., compressed, uncompressed, color, gray scale, etc.). The image data section 90 may include any quantity of image sections, each including any quantity of fields to store an image and/or any desired attributes of that image (e.g., width, height, type, etc.). The image attributes pertaining to image dimensions may be indicated in any desired fashion (e.g., inches, centimeters or other units of measurement, pixels, display or screen locations, etc.). The image type may be indicated by any desired alphanumeric or other values to indicate any types of images, colors and/or resolutions (e.g., monochromatic, gray scale, color, etc.). Each image section may include or be associated with any quantity of images.

The event synchronization section 100 may include any quantity of events 102 of any kind (e.g., display an image, etc.). The event synchronization section 100 may include any quantity of event sections, each including any quantity of fields to store any desired attributes of an event (e.g., type, time or other indicator of occurrence, etc.). The event attribute pertaining to time may be indicated in any desired fashion (e.g., time of day, time from a reference point, etc.). The event identification may be indicated by any desired alphanumeric or other values to indicate any types of events (e.g., display of an image, etc.). The image address may be indicated by any suitable pointers or addresses (e.g., direct addresses, offsets or indirect addresses relative to any suitable starting address, etc.) to indicate the locations of the image. Each event section may include or be associated with any quantity of events, where each event may control display of any quantity of images. The event section may include any type of identifier to indicate the proper time for occurrence of an event (e.g., a specific time or time range, range of addresses or data accessed, etc.).

The file format of the present invention embodiments for a plurality of presentations may include any quantity of fields to store any desired information (e.g., quantities, filenames or other file addresses or attributes, etc.). The fields may be arranged in any desired fashion or order. The fields may be of any quantity, may include any desired storage capacity or length, and may store data of any type or form (e.g., numeric, text or string, integer, real, binary, hexadecimal, octal, etc.). The file format may include any quantity of multimedia or other selections and may indicate the order for presentation in any fashion (e.g., a field may indicate the order or type of order, the order of the fields may indicate presentation order, etc.).

It is to be understood that the data structures, file formats and software for the computer systems and device processor of the present invention embodiments may be implemented in or utilize standards or syntax of any desired computer languages or file formats (e.g., tags, etc.). The data structures or file formats may be implemented by any suitable types of data structures (e.g., file, record, linked list, array, etc.) and be stored on any suitable device with a computer readable medium. Further, the software for the computer systems and device processor could be developed by one of ordinary skill in the computer arts based on the drawings and functional descriptions contained in the specification. Further, any references herein of software performing various functions generally refer to computer systems or processors performing those functions under software control.

The present invention embodiments are not limited to the specific applications described above, but may be utilized to embed and synchronize any types of information with other information (e.g., embed and synchronize text with images, audio or video, embed and synchronize audio with text, images or video, etc.).

From the foregoing description, it will be appreciated that the invention makes available a novel method and apparatus for storage, retrieval and synchronization of multimedia data, wherein image data is embedded within audio information in a manner accommodating various sized images and enabling synchronization of the embedded image data with specific instances of an audio presentation.

Having described preferred embodiments of a new and improved method and apparatus for storage, retrieval and synchronization of multimedia data, it is believed that other modifications, variations and changes will be suggested to those skilled in the art in view of the teachings set forth herein. It is therefore to be understood that all such variations, modifications and changes are believed to fall within the scope of the present invention as defined by the appended claims.

I/We hereby claim:

1. An apparatus including a computer readable medium with a data structure recorded thereon for embedding and synchronizing a second type of multimedia information with a first type of multimedia information to provide a multimedia presentation, said data structure including:
a first section to store said first type of multimedia information and at least one attribute thereof;
a second section to store said second type of multimedia information and at least one attribute thereof; and
a synchronization section to store information directing occurrence of events during said multimedia presentation to synchronize said first and second types of multimedia information and enable embedding of said second type with said first type to provide said multimedia presentation to a user.

2. The apparatus of claim 1, wherein said first type of multimedia information includes audio information and said second type of multimedia information includes image information.

3. The apparatus of claim 2, wherein said data structure further includes:
an information section including information pertaining to said multimedia presentation;
a rights section including information pertaining to access of said data structure; and
a header section including information pertaining to locations of said sections within said data structure.

4. The apparatus of claim 2, wherein said at least one attribute of said audio information includes an amount of said audio information stored within said first section.

5. The apparatus of claim 2, wherein said second section includes a plurality of image sections each including image information and at least one attribute of a corresponding image.

6. The apparatus of claim 5, wherein said at least one attribute of said corresponding image includes at least one of an image type, an image width and an image height.

7. The apparatus of claim 2, wherein said synchronization section includes a plurality of event sections each including information pertaining to a corresponding event within said multimedia presentation.

8. The apparatus of claim 7, wherein each event section includes an event identifier to indicate a type of event and an event performance indication to identify a time within said multimedia presentation to perform said indicated event.

9. The apparatus of claim 8, wherein said event type includes display of an image, and said event section further includes a location of an image within said second section to be displayed.

10. The apparatus of claim 1, wherein said multimedia presentation includes one of a song and a story.

11. The apparatus of claim 1, wherein said computer readable medium further includes a second data structure including a list of identifiers each identifying a corresponding data structure with a desired multimedia presentation, and wherein said list enables said identified multimedia presentations to be successively presented to said user.

12. The apparatus of claim 1, wherein said apparatus includes a removable storage device accessible by a presentation device to present said multimedia presentation to said user.

13. The apparatus of claim 1, wherein said apparatus includes a storage device of a computer system to enable distribution of said data structure by said computer system to a presentation device to present said multimedia presentation to said user.

14. The apparatus of claim 13, wherein said computer system includes at least one of a server system and an end-user system in communication with said server system via a network.

15. A method of embedding and synchronizing a second type of multimedia information with a first type of multimedia information to provide a multimedia presentation, said method comprising:
(a) storing said first type of multimedia information and at least one attribute thereof in a first section of a data structure;
(b) storing said second type of multimedia information and at least one attribute thereof in a second section of said data structure; and
(c) indicating events to be performed during said multimedia presentation to synchronize said first and second types of multimedia information and enable embedding of said second type with said first type to provide said multimedia presentation to a user, wherein said indication of event occurrence is stored in a synchronization section of said data structure.

16. The method of claim 15, wherein said first type of multimedia information includes audio information and said second type of multimedia information includes image information.

17. The method of claim 16, wherein step (b) further includes:
(b.1) storing information pertaining to said multimedia presentation in an information section of said data structure;
(b.2) storing information pertaining to access of said data structure in a rights section of said data structure; and
(b.3) storing information pertaining to locations of said sections within said data structure in a header section of said data structure.

18. The method of claim 16, wherein said at least one attribute of said audio information includes an amount of said audio information stored within said first section, and step (a) further includes:
(a.1) storing said amount attribute within said first section.

19. The method of claim 16, wherein said second section includes a plurality of image sections, and step (b) further includes:
(b.1) storing image information and at least one corresponding image attribute within a corresponding image section.

20. The apparatus of claim 19, wherein said at least one corresponding image attribute includes at least one of an image type, an image width and an image height.

21. The method of claim 16, wherein said synchronization section includes a plurality of event sections, and step (c) further includes:
(c.1) storing information pertaining to an event within said multimedia presentation in a corresponding event section.

22. The method of claim 21, wherein said event information includes an event identifier to indicate a type of event and an event performance indication to identify a time within said multimedia presentation to perform said indicated event.

23. The apparatus of claim 22, wherein said event type includes display of an image, and said event information further includes a location of an image within said second section to be displayed.

24. The method of claim 15, wherein said multimedia presentation includes one of a song and a story.

25. The method of claim 15, further including:
(d) storing a list of identifiers within a second data structure, wherein each identifier identifies a corresponding data structure with a desired multimedia presentation, and wherein said list enables said identified multimedia presentations to be successively presented to said user.

26. The method of claim 15, further including:
(d) storing said data structure within a removable storage device accessible by a presentation device to present said multimedia presentation to said user.

27. The method of claim 15, further including:
(d) storing said data structure within a storage device of a computer system to enable distribution of said data structure by said computer system to a presentation device to present said multimedia presentation to said user.

28. The method of claim 27, wherein said computer system includes at least one of a server system and an end-user system in communication with said server system via a network.
